(19) United States
(12) Patent Application Publication
(10) Pub. No.: US 2008/0168423 A1
(43) Pub. Date: Jul. 10, 2008

(54) CHARACTERIZING SOFTWARE COMPONENTS OR SOA SERVICES OF A COMPUTERIZED SYSTEM BY CONTEXT

(76) Inventors: Shalom Daskal, Ramat Efal (IL); Avraham Kochva, Kfar Haroe (IL); Ronen Yochpaz, Tel Aviv (IL)

Correspondence Address: Fleit Gibbons Gutman Bongini & Bianco PL, 21355 EAST DIXIE HIGHWAY, SUITE 115, MIAMI, FL, 33180, US

(21) Appl. No.: 11/947,165

(22) Filed: Nov. 29, 2007

Related U.S. Application Data
(60) Provisional application No. 60/879,389, filed on Jan. 8, 2007.

(51) Int. Cl. G06F 9/44

(52) U.S. Cl. 717/120

(57) ABSTRACT

A computer implemented method, data processing system, and computer program product for characterizing software components or SOA services by context that build up a software application process running over the computerized system of a business or an organization. This is done by implementing a methodological algorithm within the application process environment. The algorithm that operates within the computerized system detects monitors, specifies and classifies each and every software component or SOA service it comes across via the user interface. Among other things, the algorithm utilizes the business logic of the business or organization. The classified software components or SOA services are then stored in a hierarchal order that corresponds with the business logic of the business or the organization.

### CROSS-REFERENCE TO RELATED APPLICATIONS

This application claims the benefit of U.S. Provisional Patent Application 60/879,389, filed Jan. 8, 2007, which is incorporated herein by reference in its entirety.

### FIELD OF THE INVENTION

The present invention relates generally to service and product oriented businesses, and more particularly, to characterizing software components or SOA services of computerized systems of such businesses by context.

### BACKGROUND OF THE INVENTION

Service Oriented Architecture (SOA) is an emerging concept where software applications are built up out of software components presented as services. These software components are defined as relatively large, intrinsically unassociated units of functionality.

An ongoing challenge in the SOA and IT development environment is to allow clients of a specific computerized system to use and reuse each and every software component or SOA service that is used by the software application running over the computerized system. SOA will enable a better software development environment improving the ability of software developers to meet the fast changing computerized needs of a business or an organization. Making the software components or SOA services available for clients requires characterizing each and every software component or SOA service in view of the business architecture and related logic of the organization.

### SUMMARY OF THE INVENTION

The present invention achieves the characterization of software components or SOA services by context that build up a software application running over the computerized system of a business or an organization. This is done by implementing a methodological algorithm within the user interface and application process environment. The algorithm that operates within the computerized system detects monitors, specifies and classifies each and every software component or SOA service within the application process that was activated via the user interface. The classified software components or SOA services are then stored in a hierarchal order that corresponds with the business architecture and related logic of the business or the organization.

Embodiments of the present invention provide a computer implemented method, data processing system, and computer program product for monitoring the user interface and application process through an event by event approach. The user interface (UI) of the computerized system serves as the gate through which the present invention operates. The events are the action or actions in each UI that activates the use of a software component or SOA service. Any monitored event leads to the execution of a monitored software component or SOA service which is then specified, classified and stored in a specific database or any other media.

### BRIEF DESCRIPTION OF DRAWINGS

The subject matter regarded as the invention will become more clearly understood in light of the ensuing description of embodiments herein, given by way of example and for purposes of illustrative discussion of the present invention only, with reference to the accompanying drawings (Figures, or simply “FIGS.”), wherein:

FIG. 1 shows a schematic block diagram depicting the elements of the system according to some embodiments of the present invention; and

FIG. 2 shows a flowchart depicting the steps of the method according to some embodiments of the present invention.

FIG. 3 shows exemplary business logic (software components) extraction which was initiated by the user interface.

The drawings together with the description make apparent to those skilled in the art how the invention may be embodied in practice.

Further, where considered appropriate, reference numerals may be repeated among the figures to indicate corresponding or analogous elements.

### DETAILED DESCRIPTION OF THE INVENTION

### Terminology

In the following application the following terms should be interpenetrated in light of the following definitions:

User Interface (or Human Machine Interface) is the aggregate of means by which people (the users) interact with a particular machine, device, computer program or other complex tool (the system). The users interface may be one of the following: a Web based user interface, a Web 2.0 based user interface, a semantic Web based user interface, a Graphical user interfaces (GUI), a Command line user interface, a Tactile user interface, a touch user interface, a attentive user interfaces, a batch user interface, a conversational Interface Agent, a crossing-based user interface, a gesture user interface, a intelligent user interface, a live user interfaces (LUI), a multi-screen user interfaces, a noncommand user interface, a reflexive user interface, a tangible user interface, a text user interface, a voice user interface, a zero-input interface, a zooming user interface, a recorded script of user interface, a recorded test scenario of a user interface, a Swing based user interface, a hyperlinked document, a networked graphical user interface, a 3270 based user interface, a VT100 based user interface, a VT200 based user interface, a VT300 based user interface, a VT400 based user interface, a widgets based user interface, a menu driven based user interface, a window based user interface, a MS-windows based user interface, a Mac-Os user interface, a Linux Os user interface, a Unix based user interface.

Application process—a sequenced set of software components or SOA services activated to catty out a business service or product.

Business Architecture—The grouping by context of business services and products offered by the business or organization into clusters (“business domains”).

Business Logic—a set of rules and policies over which the business or the organization is being operated and managed. Deriving the business logic enables to identify the business architecture and related rules of the business.

Event—any occurrence over the user interface (UI) of the computerized system of the business or the organization that triggers an activation of a software component or SOA service

Software components or SOA services—the term software component or SOA service refers to a discretely defined set of contiguous and autonomous business or technical functionality.

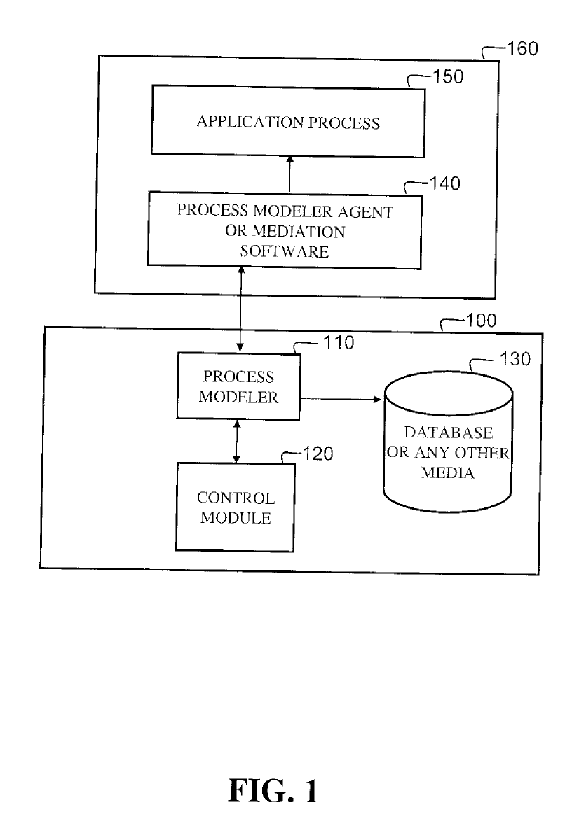

FIG. 1 shows a schematic block diagram depicting the elements of the disclosed data processing system according to some embodiments of the present invention. FIG. 1 shows a system 100 for characterizing the software components or SOA services of an application process 150 in a service or product oriented organization. The system 100 comprises a process modeler 110 connected to a control module 120 and to a database or any other media 130.

According to some embodiments of the invention, the software components or SOA services may comprise methods, classes, components, functions, programs, services, processes, assemblies, modules, DLL's, DAL's. Corba objects, COM objects, DCOM objects, objects, rules, scripts, tasks, jobs, procedures, macros, packages and any sub component that build up the application process. Upon operation of the system 100, the control module 120 receives the business logic and the flow of events. Consequently, the control module 120 notifies the process modeler 110 when to start and when to stop tracing and when to start and when to shutdown. The control module 120 can be any module that activates the different application process operations and can notify the process modeler 110 of these actions. For example, the control module 120 can be a user interface logic mapping and activation software such as a crawler that interacts with the application process via the user interface.

The process modeler 110 is further connected to a database or any other media 130 over which it saves the list of software components or SOA services detected together with the corresponding operation of the application process derived from the control module 150. By this, throughout the operation of the process modeler 110, it detects the software components and relates them to the specific operation thus characterizing them in regards to their position along the hierarchy of the business logic and their interplay with other software components. Moreover, complete knowledge of the business logic enables a comprehensive scan of the application process by the process modeler 110, as each and every event may be operated to invoke the related software components available on the computerized system.

According to some embodiments of the invention, the business logic is made available to the process modeler by data processing system that extracts the business logic from the user interface of the computerized system.

According to some embodiments of the invention, the process modeler 110 is configured to connect to the different application processes 150 either directly to the application server or through an agent or through mediation software 140. The application processes 150 may reside on multiple hosts 160 and the process modeler connects to all of the processes 150 on all of the different hosts 160.

According to some embodiments of the invention, the service and/or product oriented organization may be any of the following: a financial organization (e.g., banks, insurance companies), telecommunication companies, energy companies, transportation companies, utilities companies, computer companies, software companies, retail companies, healthcare companies as well as non-for-profit organizations such as governmental agencies.

According to some embodiments of the invention the application process may be a JVM process, a .Net CLR process, a BPEL process, a TP software transaction, an LMS transaction, a CICS transaction, MS-Dos process, MS-windows process, MS-Windows CE process, Unix-OS process, Z/OS process, MAC/OS process, QNX OS process, VxWorks OS process, Palm OS process, PSOS process, RTOS process, Linux process, Mainframe process, TCP/IP process, SNA process, NFS process, LU x process, XML process, file transfer process, Minix process, BSD process, Batch process or any of the like.

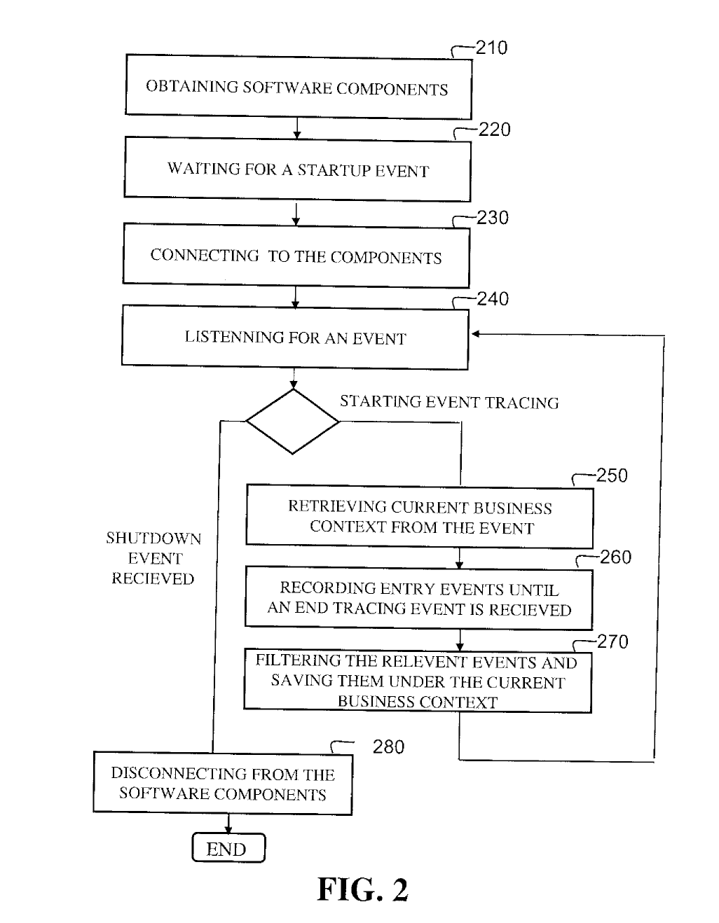

FIG. 2 is a flowchart depicting the steps of the method according to some embodiments of the present invention. Following these steps yields an ordered list of software components or SOA services in conjunction with the specific actions that invoked the use of the software components on the computerized system as operated via the user interface (UI). On step 210, a plurality of software components or SOA services that build up the software application are obtained. As the present invention support a variety of environments, a corresponding locator for each software component or SOA service is provided. For example, in the case of a Java based software component, a hostname and a port will suffice. For a .Net based software component, a process ID will suffice. In addition for each software component a filter may be specified to filter out system environment related software components. For example, in the Java environment all methods belonging to the java.* or sun.java.* packages should be filtered out. On step 220 a startup event is being waited for. Then, on step 230, the connection to all the software components is established. According to some embodiments, the method of connection may vary depending on the type of software component. For example, a Java process can be run under a JVM with remote debugging option under a specific port enabled. For a .Net software component, there is an agent on the host that is running the process and a connection will be made from a process modeler to a remote debugging agent.

In step 240 listening for one of two events either a start tracing event or a shutdown event take place. In step 250 a start tracing event is received and retrieve business context from the event. In step 260 tracing the software components are started and the components characteristics are monitored and recorded. When an end tracing event is received in step 270, the recorded components are filtered and saved according to the current and relevant business logic reflecting the business context. It then waits for the next start tracing or shutdown event. If no shutdown occurs in a timeframe the system activates a shutdown process. In step 280 a shutdown event is received and a disconnection from all the processes before shutting down is performed.

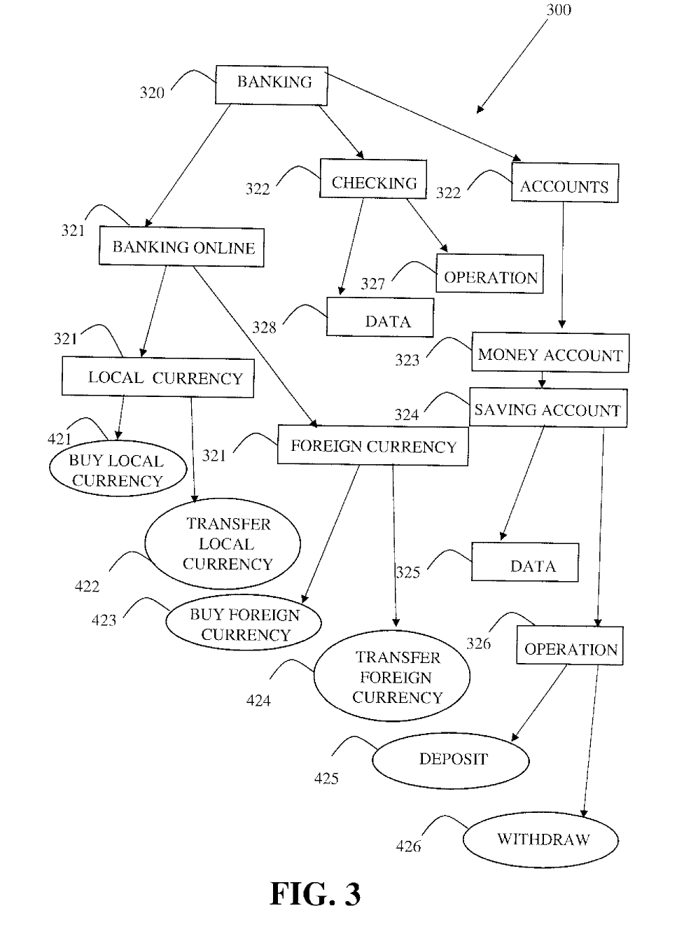

FIG. 3 shows the output of the present invention. For practical reasons, only a small segment of an exemplary contextual architecture of a financial institution is provided. Specifically, the business architecture is derived independently and provided for the algorithm of the present invention together with the software components or SOA services to be classified. The components are classified in view of their properties and their hierarchy as derived from their location within the business context. It may be shown that various operation and data retrieving may be drilled down from the lower sub categories of the hierarchical business architecture tree. More specifically, in the banking parent service, the software component or SOA service related to buying and transferring local and foreign currency (421, 422, 423 and 424) are arranged in accordance with the hierarchy. Similarly, data retrieving (325) and banking operations (326) are attributed to their corresponding sub categories. Thus, after mapping and tracing each and every software component or SOA service to its hierarchical location any user may be provided with better knowledge and access to the IT resources of the organization.

According to some embodiments of the invention, the connection to the application process may be achieved through an agent or an exit or a monitor or tracing monitor on the host running the process.

According to some embodiments of the invention, the system can be implemented in digital electronic circuitry, or in computer hardware, firmware, software, or in combinations of them. Apparatus of the invention can be implemented in a computer program product tangibly embodied in an information carrier, e.g., in a machine-readable storage device or in a propagated signal, for execution by a programmable processor; and method steps of the invention can be performed by a programmable processor executing a program of instructions to perform functions of the invention by operating on input data and generating output.

The invention can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the invention can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The invention can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention can be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the embodiments. Those skilled in the art will envision other possible variations, modifications, and applications that are also within the scope of the invention. Accordingly, the scope of the invention should not be limited by what has thus far been described, but by the appended claims and their legal equivalents. Therefore, it is to be understood that alternatives, modifications, and variations of the present invention are to be construed as being within the scope and spirit of the appended claims.

What is claimed is:

1. A data processing system for characterizing software components or SOA services of a computerized system running an application process, said data processing system comprising:
a control module; connected to
a process modeler; connectable to said application process running over said computerized system;
said process modeler configured to trace software components or SOA services operating at any given time on said application process;
said control module is configured to receive business logic information and events and to consequently schedule the process modeler to trace software components or SOA services;
wherein said control module is further configured to classify the business context of each software component or SOA service traced by said process modeler.

2. The data processing system of claim 1 further comprising a database connected to said control module; wherein said control module is further configured to store data regarding the business logic hierarchy of each software component or SOA service traced by said process modeler.

3. The data processing system of claim 1 wherein said application processes reside on multiple hosts and wherein said process modeler connects to all of said application processes on all said different hosts.

4. The data processing system of claim 1 wherein said control module is a user interface logic mapping and activation software such as a crawler or testing tool or debugging tool that interacts with the application process.

5. The data processing system of claim 1 wherein the business logic is obtained via the user interface of said computerized system.

6. The data processing system of claim 1 further comprising an agent module; wherein said process modeler is connectable to said application process via said agent module and wherein said agent module is configured to manage the interaction between said process modeler and said application process.

7. The data processing system of claim 1 further using mediation software; wherein said process modeler is connectable to said application process via said mediation software and wherein said mediation software is configured to manage the interaction between said process modeler and said application process.

8. The data processing system of claim 1 further using an agent and mediation software; wherein said process modeler is connectable to said application process via said agent and mediation software and wherein agent said and mediation software is configured to manage the interaction between said process modeler and said application process.

9. The data processing system of claim 1 wherein said application process is at least one of the following: a JVM process, a .Net CLR process, a BPEL process, a TP software transaction, an IMS transaction, a CICS transaction, a X/Open Distributed Transaction Processing (DTP), an Application Control Management System (ACMS), a Database transaction, a Java EE, a Transaction Processing Facility (TPF). MS-Dos process, MS-windows process, MS-Windows CE process, Unix-OS process, Z/OS process, MAC/OS process, QNX OS process, VxWorks OS process, Palm OS process, PSOS process, RTOS process, Linux process, Mainframe process, TCP/IP process, SNA process, NFS process, LU x process, XML process, file transfer process, Minix process, BSD process, Batch process.

10. A computer implemented method for characterizing software components or SOA services of a computerized system running an application process, said computer implemented method comprising the steps of:
receiving software components or SOA services of said computerized system;
receiving business logic data of said computerized system;
while tracing the operation of the application process, detecting software components or SOA services,
classifying the business context of each software component or SOA service.

11. The computer implemented method of claim 10 wherein detecting software components or SOA services is followed by storing said traced software components or SOA services on a dedicated database or any other media such that the software components or SOA services are arranged in a hierarchy corresponding to said business logic.

12. The computer implemented method of claim 10 wherein tracing the operation of the application process is performed in a predetermined exhaustive manner that covers the operation of software components or SOA services in accordance with said business logic.

13. The computer implemented method of claim 10 wherein classifying the business context of each software component or SOA service is performed by filtering the relevant events in accordance with said business logic.

14. The computer implemented method of claim 10 wherein said business logic data is extracted from the user interface of said computerized system.

15. A computer program product for characterizing software components or SOA services of a computerized system running an application process, said computer program product comprising:
a computer usable medium having computer usable program code tangibly embodied thereon, the computer usable program code comprising: computer usable program code for receiving software components or SOA services of said computerized system;
a computer usable program code for receiving business logic data of said computerized system; computer usable program code for tracing the operation of the application process in run time and detecting software components or SOA services;
a computer usable program code for classifying the business context of each software component or SOA service.

16. The computer program product of claim 15 further comprising:
a computer usable program code for storing said traced software components or SOA services on a dedicated database or any other media such that the software components or SOA services are arranged in a hierarchy corresponding to said business logic.

17. The computer program product of claim 15 wherein the computer usable program code for tracing the operation of the application process is performed in a predetermined exhaustive manner that covers the operation of software components or SOA services in accordance with said business logic.

18. The computer program product of claim 15 wherein the computer usable program code for classifying the business context of each software component or SOA service is performed by filtering the relevant events in accordance with said business logic.
